(19) United States
(12) Patent Application Publication
(10) Pub. No.: US 2008/0062166 A1
(43) Pub. Date: Mar. 13, 2008

(54) Drive control method and device for current drive circuit, display panel drive device, display apparatus and recording medium storing drive control program

(76) Inventors: Hiroshi Kojima, Kyoto (JP); Makoto Mizuki, Kyoto (JP); Tomokazu Kojima, Osaka (JP); Kazuyoshi Nishi, Kyoto (JP); Tetsuro Oomori, Osaka (JP)

Correspondence Address: MCDERMOTT WILL & EMERY LLP, 600 13TH STREET, NW, WASHINGTON, DC, 20005-3096, US

(21) Appl. No.: 11/896,949

(22) Filed: Sep. 7, 2007

(30) Foreign Application Priority Data
Sep. 7, 2006 (JP) 2006-242464
Aug. 7, 2007 (JP) 2007-205718

(51) Int. Cl. G06F 3/038

(52) U.S. Cl. 345/215; 345/214; 345/76

(57) ABSTRACT

The method includes the steps of: (a) supplying second digital data, in place of first digital data that should originally be supplied, to a current drive circuit to allow the current drive circuit to supply a drive current corresponding to the second digital data during a first time period; and (b) supplying, after step (a), the first digital data to the current drive circuit to allow the current drive circuit to supply a drive current corresponding to the first digital data during a second time period. In step (a), the digital value of the second digital data is determined based on the digital value of the first digital data so that write of a drive current corresponding to the first digital data into an circuit to be driven is completed with the supply of the drive currents during the first and second time periods.

### BACKGROUND OF THE INVENTION

The present invention relates to a technology of controlling a current drive circuit for driving a current-driven element such as organic electroluminescence (EL).

In recent years, display apparatuses using organic EL as a light-emitting element have been actively developed. Such a display apparatus includes a current drive circuit for supplying a drive current having a current value corresponding to image data and a display panel having a plurality of pixel portions. Organic EL is provided for each of the pixel portions. In such a display apparatus, the current drive circuit writes a drive current into each of the pixel portions, and organic EL in each pixel portion emits light according to the current value of the drive current written in the pixel portion, to thereby display an image on a display panel.

As described above, a drive current is written into a circuit to be driven, to thereby drive the circuit to be driven according to the current value of the drive current. During supply of the drive current, however, the drive current is used for charging/discharging a load capacitance of the current drive circuit (a parasitic capacitance of an interconnect through which the drive current is transmitted, a capacitance component in the circuit to be driven, etc.), and therefore it takes time to complete the write of the drive current into the circuit to be driven (that is, it takes time for the current flowing to the circuit to be driven to reach a target current value (current value of the drive current)). Moreover, as the current value of the drive current is smaller, a longer time is required to charge/discharge the load capacitance, with a higher possibility of failing to complete the write of the drive current within a predetermined time. For example, in a display apparatus, if write of a drive current has not been completed within a predetermined current setting time period, the drive current corresponding to image data will not be correctly held in a pixel portion, resulting in occurrence of faulty display.

To address the above problem, Japanese Laid-Open Patent Publication No. 2004-309924 (Patent Literature 1) discloses a current drive circuit in which an additional current source different from existing current sources (a plurality of current sources for generating a drive current corresponding to image data) and a switch group for forming bypass routes between the existing current sources and pixel portions of a display panel are newly provided to enable supply of a given current different from a drive current corresponding to image data. The disclosed current drive circuit supplies a given current to a pixel portion of the display panel only for a predetermined duration in the current setting time period, while supplying a drive current corresponding to image data to the pixel portion during the remaining operating time period. In this way, the time required for a current flowing to a pixel portion to reach a target current value (convergence time) can be shortened.

However, in the technology disclosed in Patent Publication 1, a circuit for supplying a given current must be additionally provided in the current drive circuit, and this increases the circuit area.

### SUMMARY OF THE INVENTION

An object of the present invention is ensuring completion of write of a drive current within a predetermined time period without increasing the circuit scale.

According to one aspect of the invention, a drive control method is a method for controlling a current drive circuit, the current drive circuit supplying a drive current having a current value corresponding to a digital value of digital data to a current-driven circuit to be driven, the method including the steps of: (a) supplying second digital data, in place of first digital data that should originally be supplied, to the current drive circuit to allow the current drive circuit to supply a drive current corresponding to the second digital data during a first time period; and (b) supplying the first digital data to the current drive circuit after the step (a) to allow the current drive circuit to supply a drive current corresponding to the first digital data during a second time period, wherein in the step (a), the digital value of the second digital data is determined based on the digital value of the first digital data so that write of a drive current corresponding to the first digital data into the circuit to be driven is completed with the supply of the drive currents during the first and second time periods.

In the drive control method described above, the charge/discharge amount of the circuit to be driven during the first time period can be adjusted by increasing/decreasing the digital value of the second digital data according to the digital value of the first digital data. This makes it possible to charge/discharge the load capacitance of the current drive circuit sufficiently even if the current value of the drive current corresponding to the first digital data is small. Also, with no additional circuit for adjusting the current amount being required in the current drive circuit, write of the drive current corresponding to the first digital data can be completed within a predetermined time period without increasing the circuit scale of the current drive circuit.

In the step (a), the digital value of the second digital data may be determined so as to be greater as the digital value of the first digital data is smaller.

Otherwise, in the step (a), the digital value of the second digital data may be determined so as to be greater than the digital value of the first digital data if the digital value of the first digital data is smaller than a predetermined value, or the digital value of the first digital data may be supplied as the second digital data if the digital value of the first digital data is equal to or greater than the predetermined value.

Preferably, the drive control method described above further includes the step of (c) initializing the voltage value of the circuit to be driven before allowing the current drive circuit to supply the drive current in the step (a).

In the drive control method described above, a residual voltage in the circuit to be driven can be removed, and the circuit to be driven can be charged/discharged appropriately during the first time period. Thus, the drive current corresponding to the first digital data can be written into the circuit to be driven correctly within a predetermined time period.

Preferably, the step (a) includes the steps of: (a1) judging which is greater, the first digital data or third digital data that is digital data previously supplied to the current drive circuit; (a2) determining the digital value of the second digital data so as to be greater as a difference value between the first digital data and the third digital data is greater if it is judged that the first digital data is equal to or greater than the third digital data in the step (a1); and (a3) initializing the voltage value of the circuit to be driven and determining the digital value of the second digital data so as to be greater as the digital value of the first digital data is smaller if it is judged that the first digital data is smaller than the third digital data in the step (a1).

In the drive control method described above, the voltage value for the drive current during the first time period is determined based on the difference value between the first digital data to be supplied this time and the third digital data already supplied. It is therefore possible to set the charge/discharge amount of the circuit to be driven during the first time appropriately. Also, whether to initialize the circuit to be driven or not is judged based on whether the first digital data is greater or smaller than the third digital data. Therefore, unnecessary initialization of the voltage value of the circuit to be driven is avoided, and thus the power consumption of the current drive circuit can be reduced.

The circuit to be driven may include a current-driven drive element, a drive transistor for supplying a current to the drive element, and a voltage hold element connected to a gate of the drive transistor for holding a gate voltage of the drive transistor. The drive control method described above may include the steps of: (d) connecting the gate and drain of the drive transistor with each other before allowing the current drive circuit to supply the drive current in the step (a), to permit the voltage hold element to hold a gate voltage of the drive transistor obtained when no current is flowing through the drive transistor; (e) connecting the drive transistor with the current drive circuit during the first and second time periods to allow the drive transistor to receive the drive current supplied from the current drive circuit and then the voltage hold element to hold a gate voltage corresponding to a current value at the drive transistor; and (f) connecting the drive transistor with the drive element after passing of the second time period to allow the drive element to receive a current corresponding to the gate voltage held in the voltage hold element.

In the drive control method described above, a residual voltage in the circuit to be driven (voltage hold element) can be removed, and thus the circuit to be driven can be charged/discharged appropriately.

According to another aspect of the invention, a drive control device is a device for controlling a current drive circuit, the current drive circuit supplying a drive current having a current value corresponding to a digital value of digital data to a current-driven circuit to be driven, the device including: a conversion section for supplying second digital data, in place of first digital data that should originally be supplied, to the current drive circuit during a first time period and supplying the first digital data to the current drive circuit during a second time period that comes after the first time period; and a control section for controlling the current drive circuit to receive the second digital data from the conversion section and supply a drive current corresponding to the second digital data during the first time period, and controlling the current drive circuit to receive the first digital data from the conversion section and supply a drive current corresponding to the first digital data during the second time period, wherein the conversion section determines the digital value of the second digital data based on the digital value of the first digital data so that write of a drive current corresponding to the first digital data into the circuit to be driven is completed with the supply of the drive currents during the first and second time periods.

In the drive control device described above, the charge/discharge amount of the circuit to be driven during the first time period can be adjusted by increasing/decreasing the digital value of the second digital data according to the digital value of the first digital data. This makes it possible to charge/discharge the load capacitance of the current drive circuit sufficiently even if the current value of the drive current corresponding to the first digital data is small. Also, with no additional circuit for adjusting the current amount being required in the current drive circuit, write of the drive current corresponding to the first digital data can be completed within a predetermined time period without increasing the circuit scale of the current drive circuit.

According to yet another aspect of the invention, a display panel drive device includes: a current drive circuit for supplying a drive current having a current value corresponding to a digital value of image data to a pixel portion of a current-driven display panel; and a drive control circuit for supplying setting preparation data, in place of image data that should originally be supplied, to the current drive circuit to allow the current drive circuit to supply a drive current corresponding to the setting preparation data during a setting preparation time period, and supplying the image data to the current drive circuit to allow the current drive circuit to supply a drive current corresponding to the image data during a current setting time period that comes after the setting preparation time period, the drive control circuit determining the digital value of the setting preparation data based on the digital value of the image data so that write of a drive current corresponding to the image data into the pixel portion with the supply of the drive currents during the setting preparation time period and the current setting time period.

According to yet another aspect of the invention, a display apparatus includes the display panel drive device described above; and a display panel having the display panel drive device embedded therein.

### BRIEF DESCRIPTION OF THE DRAWINGS

FIG. 1 is a view showing a configuration of a display apparatus of Embodiment 1 of the present invention.

FIG. 2 is a view showing a correspondence between image data and setting preparation data.

FIG. 3 is a view showing a configuration of a controller in FIG. 1.

FIGS. 4A and 4B are views illustrating a pixel portion in FIG. 1.

FIG. 5 is a flowchart of an operation of the display apparatus of FIG. 1.

FIGS. 6A and 6B are views for demonstrating a voltage change and a current change, respectively, in a pixel portion in FIG. 1.

FIG. 7 is a view for demonstrating a voltage change in a pixel portion observed when the digital value of image data is sufficiently large.

FIG. 8 is a view showing another example of data conversion table.

FIG. 9 is a flowchart of a procedure of generation of setting preparation data in Alteration 1 to Embodiment 1.

FIG. 10 is a view for demonstrating a procedure of generation of setting preparation data in Alteration 2 to Embodiment 1.

FIG. 11 is a view showing a configuration of a display apparatus of Embodiment 2 of the present invention.

FIG. 12 is a flowchart of an operation of the display apparatus of FIG. 11.

FIG. 13 is a view for demonstrating a voltage change in a pixel portion in FIG. 11.

FIG. 14 is a view for demonstrating a procedure of generation of setting preparation data in an alteration to Embodiment 2.

FIG. 15 is a view showing a configuration of a controller in Embodiment 3 of the present invention.

FIG. 16 is a view showing an example of data conversion table stored in a conversion section in FIG. 15.

FIG. 17 is a flowchart of an operation of a display apparatus of Embodiment 3

FIGS. 18A and 18B are views for demonstrating voltage changes in a pixel portion observed when current image data is greater (FIG. 18A) and smaller (FIG. 18B) than previous image data.

FIG. 19 is a view for demonstrating a procedure of generation of setting preparation data in an alteration to Embodiment 3.

FIG. 20 is a view for demonstrating initialization control over a pixel portion.

FIG. 21 is a view for demonstrating a control method adopted when a pixel portion is excessively discharged during a setting preparation time period.

### DESCRIPTION OF THE PREFERRED EMBODIMENTS

Hereinafter, preferred embodiments of the present invention will be described in detail with reference to the accompanying drawings. In the drawings, the same or equivalent components are denoted by the same reference numerals, and description thereof is not repeated.

### Embodiment 1

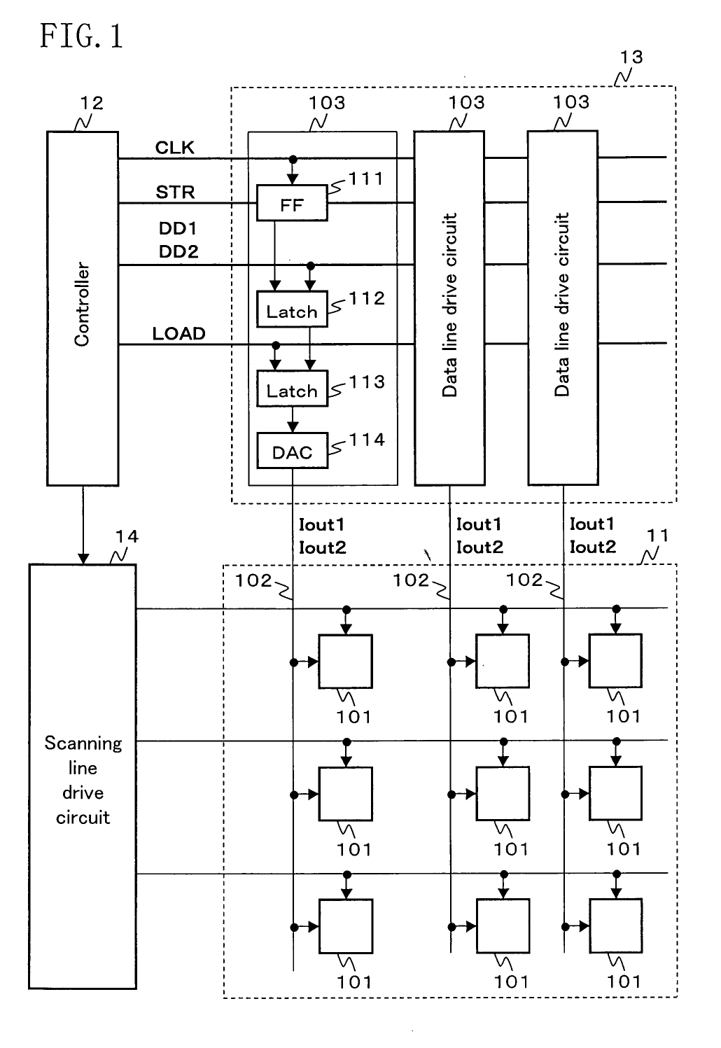

FIG. 1 shows a configuration of a display apparatus of Embodiment 1 of the present invention. The display apparatus includes a display panel 11, a controller (drive control device) 12, a current drive circuit 13 and a scanning line drive circuit 14.

The display panel 11 includes a plurality of pixel portions 101, 101, . . . arranged in matrix form and a plurality of data lines 102, 102, . . . extending in parallel with one another. Each of the pixel portions 101, 101, . . . is provided with a current-driven light-emitting element such as organic EL. Also, each of the pixel portions 101, 101, . . . is connected to one of the data lines 102, 102, . . . and has a current copy mode and a current drive mode. When being placed in the current copy mode, each pixel portion 101 receives a current supplied to the corresponding data line and holds the received current. When being placed in the current drive mode, each pixel portion 101 transfers the current held therein to the light-emitting element provided therein to allow the light-emitting element to emit light.

The controller 12 controls the current drive circuit 13 and the scanning line drive circuit 14. The controller 12 also supplies setting preparation data DD2, in place of image data DD1 that should originally be supplied, to the current drive circuit 13 during a setting preparation time period occupying a head portion of a raster cycle period, and supplies the image data DD1 during a current setting time period occupying the remaining portion of the raster cycle period. The raster cycle period refers to a time period from start of write of a current into a pixel portion 101 until the pixel portion 101 becomes a current drive mode (i.e., the organic EL emits light), and is determined based on the number of horizontal lines of the display panel 11, the frame period and the like. For example, assuming that the frame frequency is “60 Hz” and a quarter video graphics array (QVGA) panel is used, the raster cycle period will be 1/(320×60 Hz)÷50 μs.

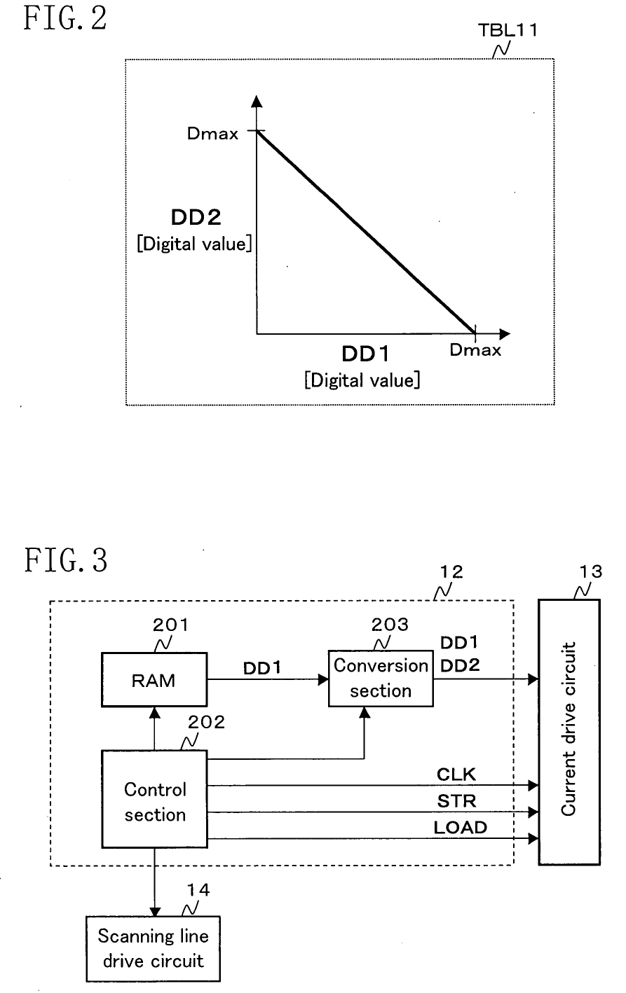

The image data DD1 is digital data defining the luminance level of a pixel. Based on the digital value of the image data DD1, the digital value of the setting preparation data DD2 is determined so that write of a drive current (drive current Iout1 corresponding to the image data DD1) for a pixel portion 101 is completed within the raster cycle period. The correspondence between the image data DD1 and the setting preparation data DD2 will be described later. Assume herein that the smaller the digital value of the image data DD1 is, the greater the digital value of the setting preparation data DD2 is, as shown in FIG. 2. Also, the maximum value of the setting preparation data DD2 is equal to or smaller than the maximum value of the image data DD1.

The current drive circuit 13 includes a plurality of data line drive sections 103, 103, . . . respectively corresponding to the data lines 102, 102, . . . of the display panel 11. Each of the data line drive sections 103, 103, . . . includes a flipflop (FF) 111, latches 112 and 113 and a digital/analog converter (DAC) 114. The FF 111 transfers a capture start signal STR from the preceding stage to the following stage in synchronization with a clock signal CLK from the controller 12. The latch 112 captures digital data (image data DD1 or setting preparation data DD2) from the controller 12 in synchronization with the output of the FF 111. The latch 113 transfers the digital data held in the latch 112 to the DAC 114 in synchronization with an output instruction signal LOAD from the controller 12. The DAC 114 outputs a drive current Iout1 (or Iout2) having a current value corresponding to the digital value of the digital data from the latch 113. The drive current is proportional to the digital data, in which the greater the digital value of the digital data is, the greater the current value of the drive current is. In this way, the data line drive sections 103, 103, . . . capture their corresponding digital data (image data DD1 or setting preparation data DD2) in turn starting from the head data line drive section 103, and supply corresponding drive currents in response to the control of the controller 12.

The scanning line drive circuit 14 drives the plurality of pixel portions 101, 101, of the display panel 11 every horizontal line. To state more specifically, the scanning line drive circuit 14 selects pixel portions 101, 101, . . . belonging to one horizontal line to turn the operation mode of the selected pixel portions 101, 101, . . . to the current copy mode during the setting preparation time period and the current setting time period (that is, the raster cycle period) and to the current drive mode during a light emission time period.

FIG. 3 shows an internal configuration of the controller 12 in FIG. 1. The controller 12 includes: a RAM 201 for storing therein a plurality of units of image data DD1, DD1, . . . ; a control section 202 for executing control of the current drive circuit 13 and the scanning line drive circuit 14, as well as control of the blocks in the controller 12; and a conversion section 203 having a conversion mode and a non-conversion mode.

The control section 202 outputs the clock signal CLK, the capture start signal STR allowing the current drive circuit 13 to start capture of data, and the output instruction signal LOAD allowing the current drive circuit 13 to start supply of a drive current. The control section 202 also executes setting of the operation mode of the conversion section 203 and transfer of the image data DD1 from the RAM 201 to the conversion section 203.

The conversion section 203 supplies the setting preparation data DD2 corresponding to the image data DD1 transferred from the RAM 201 to the current drive circuit 13 when being placed in the conversion mode, and supplies the image data DD1 as it is when being placed in the non-conversion mode. For example, the conversion section 203 has a register for holding a conversion table TBL11 indicating the correspondence between the image data DD1 and the setting preparation data DD2 as shown in FIG. 2, and determines the digital value of the setting preparation data DD2 using the conversion table TBL11.

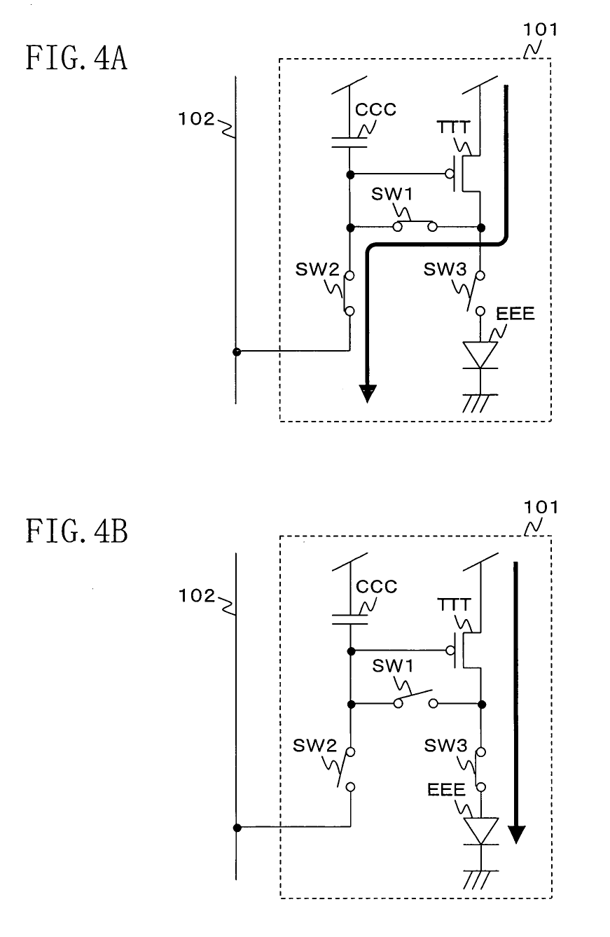

Referring to FIGS. 4A and 4B, a pixel portion 101 in FIG. 1 will be described. The pixel portion 101 includes a current-driven light-emitting element EEE such as organic EL, a drive transistor TTT, a capacitor CCC (voltage hold element) and switches SW1, SW2 and SW3 (connection state switch elements).

As shown in FIG. 4A, when the pixel portion 101 is placed in the current copy mode, in which the switches SW1 and SW2 are ON while the switch SW3 is OFF, a current starts to flow through the drive transistor TTT and the capacitor CCC is charged/discharged. Once the current value at the drive transistor TTT becomes equal (roughly equal) to the current value of the drive current supplied to the data line 102, the gate voltage of the drive transistor TTT has a voltage value corresponding to the drive current, and the capacitor CCC holds the gate voltage of the drive transistor TTT. In this way, the drive current supplied to the data line 102 is written into the pixel portion 101.

As shown in FIG. 4B, when the pixel portion 101 is placed in the current drive mode, in which the switches SW1 and SW2 are OFF while the switch SW3 is ON, the current corresponding to the voltage held in the capacitor CCC is supplied to the light-emitting element EEE from the drive transistor TTT to allow the light-emitting element EEE to emit light. In this way, the pixel portion 101 is driven in accordance with the current value of the drive current held therein.

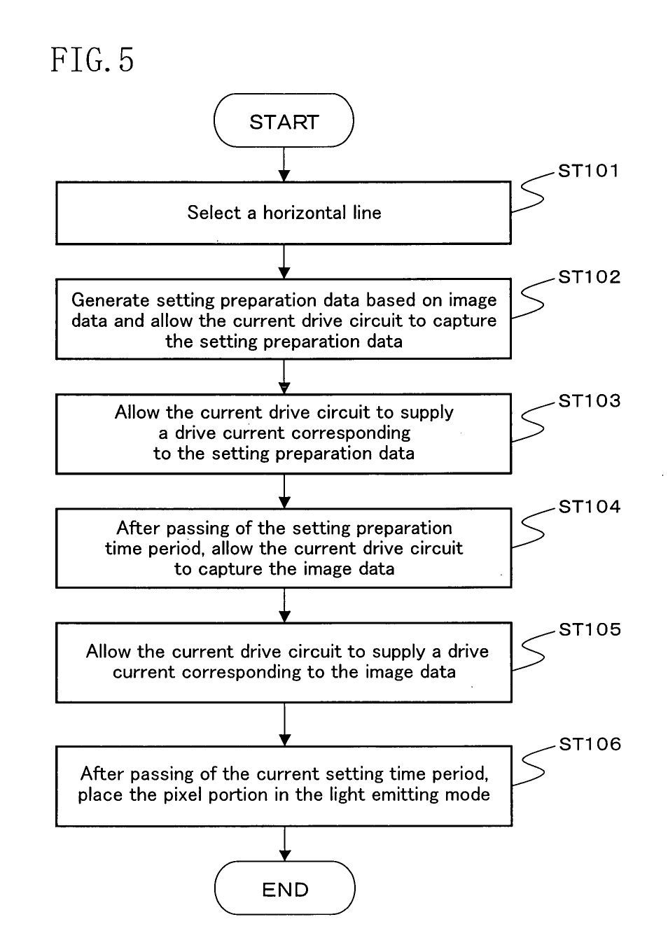

The operation of the display apparatus of FIG. 1 will be described with reference to FIG. 5.

[Step ST101]

First, the scanning line drive circuit 14 selects pixel portions 101, 101, . . . belonging to any given horizontal line of the display panel 11, and turns the operation mode of the selected pixel portions 101, 101, . . . to the current copy mode.

[Step ST102]

In the controller 12, the control section 202 sets the operation mode of the conversion section 203 at the conversion mode. The control section 202 also transfers image data DD1, DD1, . . . one by one in order from the RAM 201 to the conversion section 203. As a result, the setting preparation data DD2, DD2, . . . corresponding to the image data DD1, DD1, . . . are supplied one by one in order from the controller 12 to the current drive circuit 13. Also, the control section 202 outputs the capture start signal STR, with which the data line drive sections 103, 103, . . . of the current drive circuit 13 respectively capture the corresponding setting preparation data DD2.

[Step ST103]

Once the supply of the setting preparation data DD2, DD2, . . . of one horizontal line has been completed, the control section 202 issues the output instruction signal LOAD. In response to this, each of the data line drive sections 103, 103, . . . of the current drive circuit 13 starts supplying the drive current Iout2 having a current value corresponding to the digital value of the setting preparation data DD2 held therein to the corresponding data line 102. In this way, supply of the drive currents Iout2, Iout2, . . . to the data lines 102, 102, . . . continues over the setting preparation time period, permitting discharge of the load capacitance of each of the data line drive sections 103, 103, . . . (the parasitic capacitance of the data line 102, a capacitance component of the pixel portion 101, etc.).

[Step ST104]

Once the setting preparation time period has passed, in the controller 12, the control section 202 sets the operation mode of the conversion section 203 at the non-conversion mode. The control section 202 also transfers again the image data DD1, DD1, . . . processed in the step ST102 one by one in order from the RAM 201 to the conversion section 203. As a result, the image data DD1, DD1, . . . are supplied one by one in order from the controller 12 to the current drive circuit 13. Also, the control section 202 outputs again the capture start signal STR, with which the data line drive sections 103, 103, . . . of the current drive circuit 13 respectively capture the corresponding image data DD1.

[Step ST105]

Once the supply of the image data DD1, DD1, . . . of one horizontal line has been completed, the control section 202 issues again the output instruction signal LOAD to the current drive circuit 13. In response to this, each of the data line drive sections 103, 103, . . . of the current drive circuit 13 starts supplying the drive current Iout1 having a current value corresponding to the digital value of the image data DD1 held therein to the corresponding data line 102. In this way, supply of the drive currents Iout1, Iout1, . . . to the data lines 102, 102, . . . continues over the current setting time period, permitting write of the drive currents Iout1, Iout1, . . . into the pixel portions 101, 101, . . .

[Step ST106]

Once the current setting time period has passed, the scanning line drive circuit 14 changes the operation mode of each pixel portion 101 from the current copy mode to the current drive mode. With this, in each of the pixel portions 101, 101, . . . of the display panel 11, the current corresponding to the voltage held in the capacitor CCC is supplied to the light-emitting element EEE to allow the light-emitting element EEE to emit light. Also, the scanning line drive circuit 14 newly selects pixel portions 101, 101, . . . belonging to a horizontal line to be processed next.

Thus, the processing described above is executed for each horizontal line, permitting the drive current Iout1 corresponding to the image data DD1 to be written into the pixel portions 101, 101, . . . sequentially.

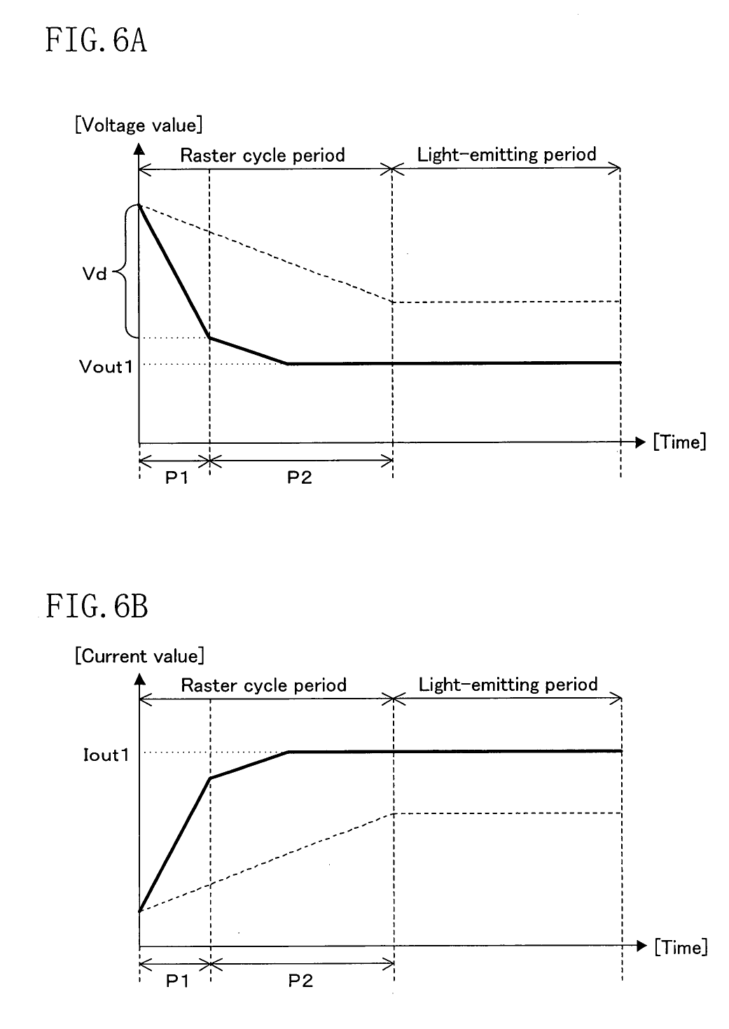

Hereinafter, the voltage change and the current change in one pixel portion 101 of the display panel 11 will be described with reference to FIGS. 6A and 6B.

The smaller the digital value of the image data DD1 is, the smaller the current value of the drive current Iout1 corresponding to the image data DD1 is. Therefore, as shown by the broken lines in FIGS. 6A and 6B, if only the drive current Iout1 corresponding to the image data DD1 is continuously supplied to a pixel portion 101, the voltage value of the pixel portion 101 (voltage value of the capacitor CCC) will fail to reach a target voltage value Vout1 (gate voltage value of the drive transistor TTT obtained when the current value at the drive transistor TTT is equal to the current value of the drive current Iout1). This indicates that the current value at the pixel portion 101 (current value at the drive transistor TTT) will not be made equal to the current value of the drive current Iout1 within the raster cycle period.

For example, assume the following:

Raster cycle period: 50 μs

Drive current Iout1 corresponding to image data DD1: 10 nA Difference between the voltage value of a pixel portion 101 at the start of discharge and the target voltage value Vout1: 3 V

Capacitance value of the load capacitance of the current drive circuit 13: 50 pF Then, the time (convergence time) required for the voltage value of the pixel portion 101 to reach the target voltage value Vout1 will be

(50 pF×3V)/101 nA=150 ms,

which is longer than the raster cycle period (50 μs).

On the contrary, in this embodiment, when the setting preparation time period P1 is started, discharge of the load capacitance of the current drive circuit 13 (data line drive section 103) with the drive current Iout2 corresponding to the setting preparation data DD2 is started. That is, as shown by the solid lines in FIGS. 6A and 6B, in the pixel portion 101, the current value at the drive transistor TTT sharply increases with a sharp drop of the gate voltage value of the drive transistor TTT. As a result, during the setting preparation time period P1, the pixel portion 101 is discharged by a voltage amount Vd. Thereafter, when the current setting time period P2 is started, the drive current Iout1 corresponding to the image data DD1 is supplied to the pixel portion 101 via the data line 102. At this time, since the voltage value of the pixel portion 101 has been sufficiently lowered, it is possible for the voltage value of the pixel portion 101 to reach the target voltage value Vout1 within the current setting time period P2 even if the current value of the drive current Iout1 is small. Thus, the current value at the pixel portion 101 can be made equal to the current value of the drive current Iout1.

For example, assume the following:

Raster cycle period: 50 μs

Setting preparation time period: 7.49 μs

Current setting time period: 42.51 μs

Drive current Iout2 corresponding to image data DD2: 20 μA

Drive current Iout1 corresponding to image data DD1: 10 nA

Difference between the voltage value of the pixel portion 101 at the start of discharge and the target voltage value Vout1: 3 V

Capacitance value of the load capacitance of the current drive circuit: 50 pF Then, the discharge amount Vd at the pixel portion 101 during the setting preparation time period P1 will be

(20 μA×7.49 μs)/50 pF=2.996 V.

In other words, by discharging the pixel portion 101 by 0.004 V during the current setting period P2, the voltage value of the pixel portion 101 can reach the target voltage value Vout1. The time (convergence time) required for the voltage value of the pixel portion 101 to reach the target voltage value Vout1 is

(50 pF×0.004 V)/10 nA=20 μs,

indicating that the voltage value of the pixel portion 101 can be converged to the target voltage value Vout1 halfway through the current setting time period P2. In other words, write of the drive current Iout1 into the pixel portion 101 can be completed within the raster cycle period.

Hereinafter, the correspondence between the image data DD1 and the setting preparation data DD2 will be described in detail. In the current drive circuit 13, the image data DD1 (setting preparation data DD2) and the drive current Iout1 (Iout2) are proportional to each other. In other words, the current value of the drive current Iout1 will be known once the digital value of the image data DD1 is determined. Also, the discharge amount of the pixel portion 101 during the current setting time period P2 can be calculated based on the current value of the drive current Iout1 and the length of the current setting time period P2. Having the discharge amount during the current setting time period P2 thus calculated, it is possible to determine the discharge amount Vd required during the setting preparation time period P1 to ensure convergence of the voltage of the pixel portion 101 to the target voltage value Vout1 within the raster cycle period. Based on the determined discharge amount Vd and the length of the setting preparation time period P1, the current value of the drive current to be supplied during the setting preparation time period P1 (i.e., the current value of the drive current Iout2) can be calculated. Having the current value of the drive current Iout2 thus calculated, the digital value of the setting preparation data DD2 can be determined. In this way, the setting preparation data DD2 corresponding to the image data DD1 can be acquired.

As described above, by increasing/decreasing the digital value of the setting preparation data DD2 depending on the digital value of the image data DD1, the discharge amount Vd during the setting preparation time period P1 can be adjusted. With this adjustment, the load capacitance of the current drive circuit 13 can be sufficiently discharged even if the current value of the drive current Iout1 corresponding to the image data DD1 is small.

Also, no additional circuit for adjusting the current amount is required in the current drive circuit 13. Therefore, write of the drive current corresponding to the image data DD1 can be completed within a predetermined time period without increasing the circuit scale of the current drive circuit.

Moreover, the current value of the drive current Iout2 supplied during the setting preparation time period can be changed by rewriting the correspondence indicated in the conversion table TBL11. This permits easy setting of the current value of the drive current Iout2 depending on the properties of the current drive circuit 13 and the properties of the display panel 11. Having such high versatility, the controller 12 can be applied to various types of current drive circuits and display panels.

### Alteration 1 to Embodiment 1

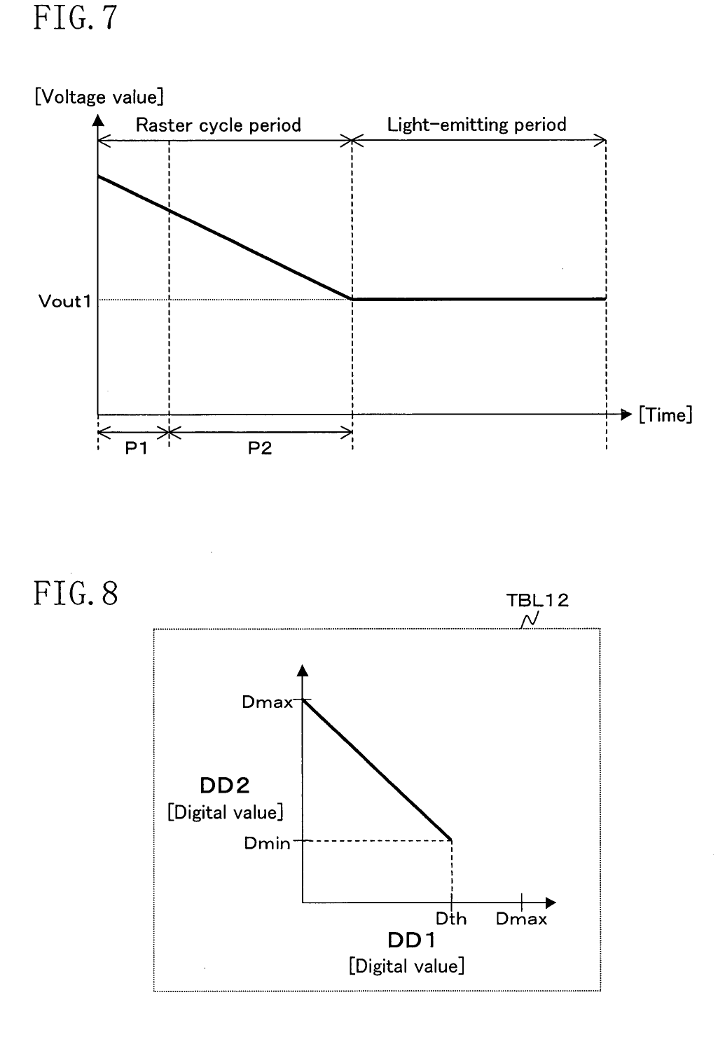

If the digital value of the image data DD1 is sufficiently large, it may be possible to converge the voltage value of the pixel portion 101 to the target voltage value Vout1 within the raster cycle period by continuing supplying only the drive current Iout1 to the pixel portion 101, as shown in FIG. 7. In other words, if the digital value of the image data DD1 is sufficiently large, only the image data DD1 may be supplied without being changed to the setting preparation data DD2. Assuming that the minimum digital value of such image data DD1 is “Dth”, no correspondence with the digital value of the setting preparation data DD2 will be necessary as long as the digital value of the image data DD1 is equal to or more than the predetermined value Dth, as shown in FIG. 8. Note herein that the digital value of the setting preparation data DD2 is greater than the digital value of the image data DD1.

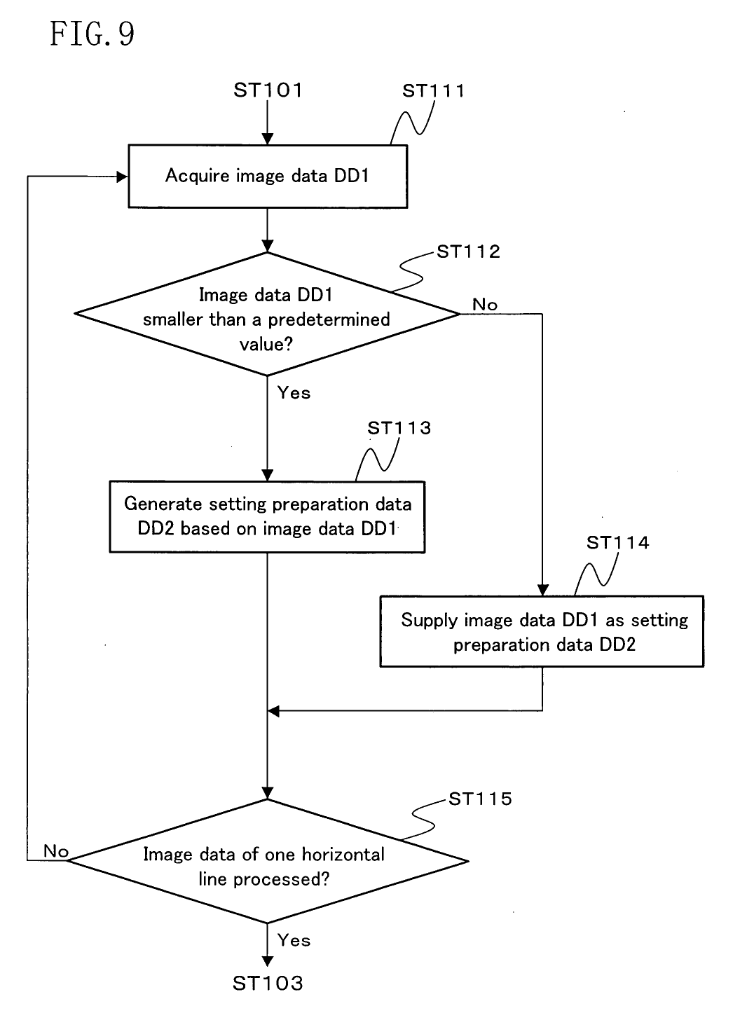

Alteration 1 to the processing of conversion from the image data DD1 to the setting preparation data DD2 (processing of the step ST102 shown in FIG. 5) will be described with reference to FIG. 9.

First, the conversion section 203 acquires the image data DD1 from the RAM 201 (step ST111). The conversion section 203 then judges whether or not the digital value of the image data DD1 is smaller than the predetermined value Dth (step ST112). If the digital value of the image data DD1 is smaller than the predetermined value Dth, the conversion section 203 generates the setting preparation data DD2 corresponding to the image data DD1 using a conversion table TBL12 (see FIG. 8) and supplies the generated setting preparation data DD2 to the current drive circuit 13 (step ST113). If the digital value of the image data DD1 is equal to or greater than the predetermined value Dth, the conversion section 203 supplies the image data DD1 as the setting preparation data DD2 (step ST114). The above processing is executed repeatedly until image data DD1 of one horizontal line has been processed (step ST115). With the control described above, the substantially the same effect as that described above can also be obtained.

### Alteration 2 to Embodiment 1

The configuration may be made so that the length of the setting preparation time period P1 can be set arbitrarily with external control and the like. Also, in the conversion of the image data DD1 to the setting preparation data DD2, the digital value of the setting preparation data DD2 may be determined based on the digital value of the image data DD1, the length of the setting preparation time period P1 and the load capacitance of the current drive circuit 13 (the parasitic capacitance of the data line 102 through which the drive current is transmitted, a capacitance component in the pixel portion 101, etc.).

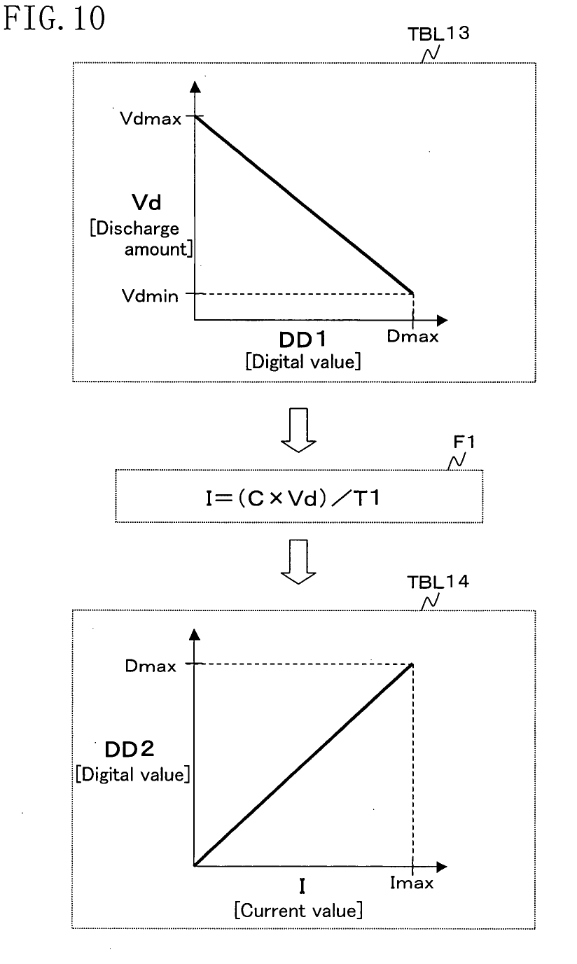

Referring to FIG. 10, Alteration 2 to the processing of the step ST102 shown in FIG. 5 will be described. Assume that the conversion section 203 has conversion tables TBL13 and TBL14 and a conversion equation F1.

The conversion table TBL13 indicates the correspondence between the image data DD1 and the discharge amount Vd of the pixel portion 101 during the setting preparation time period P1, in which the smaller the digital value of the image data DD1 is, the greater the discharge amount Vd is. The minimum value Vdmin of the discharge amount Vd may be “0 V”. In the conversion equation F1, “I” denotes a desired value of the drive current Iout2 corresponding to the setting preparation data DD2, “C” denotes the capacitance value of the load capacitance of the current drive circuit 13, and “T1” denotes the length of the setting preparation time period P1. The conversion table TBL14 indicates the correspondence between the desired value of the drive current Iout2 and the setting preparation data DD2, in which the desired value of the drive current Iout2 and the digital value of the setting preparation data DD2 are proportional to each other.

First, the capacitance value C of the load capacitance of the current drive circuit 13 and the length T1 of the setting preparation time period are set with external control. Thereafter, the conversion section 203 acquires the discharge amount Vd corresponding to the digital value of the image data DD1 using the conversion table TBL13 and then substitutes the acquired discharge amount Vd, the capacitance value C and the length T1 of the current setting time period into the conversion equation F1, to calculate the desired value I of the drive current Iout2. The conversion section 203 then determines the digital value of the setting preparation data DD2 corresponding to the calculated desired value I of the drive current Iout2 using the conversion table TBL14.

As described above, the digital value of the setting preparation data DD2 is determined based on various parameters related to the current drive circuit 13 and the display panel 11. This permits appropriate setting of the discharge amount Vd during the setting preparation time period P1, and thus correct write of the drive current Iout1 corresponding to the image data DD1 into the pixel portion 101.

### Embodiment 2

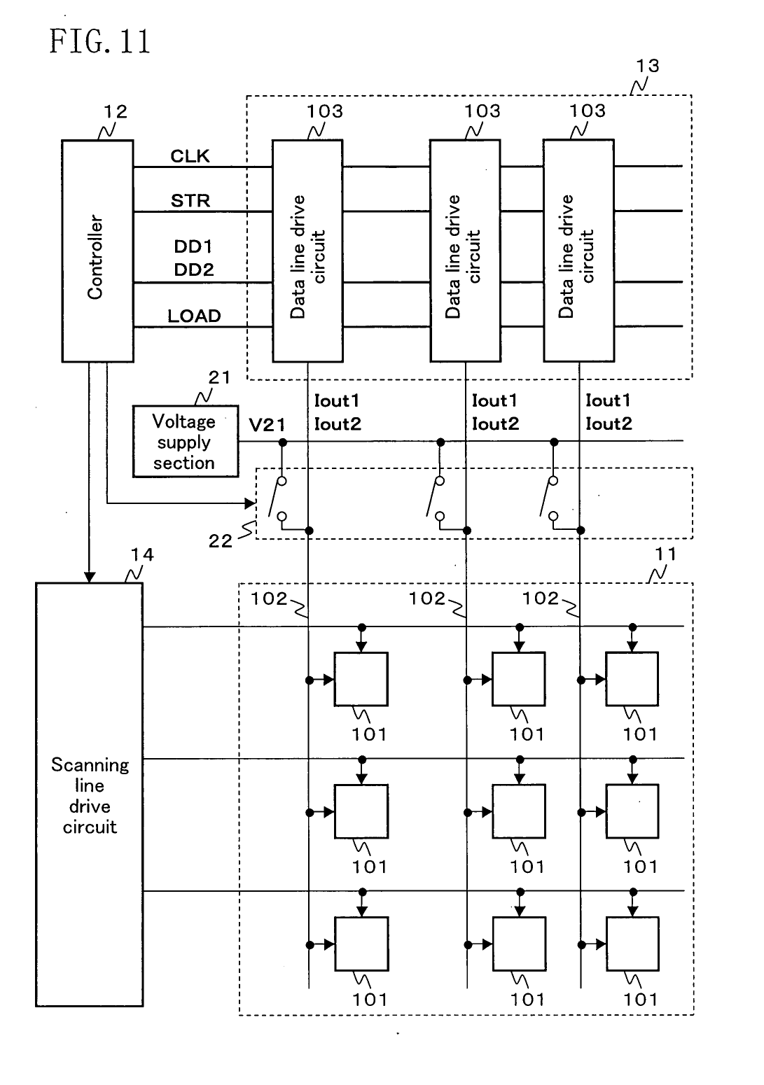

FIG. 11 shows a configuration of a display apparatus of Embodiment 2 of the pre-sent invention. This display apparatus includes not only the components illustrated in FIG. 1 but also a voltage supply section 21 and a connection switch section 22. The voltage supply section 21 supplies an initialization voltage V21 for initializing the voltage value of each data line 102. The connection switch section 22 connects or disconnects the voltage supply section 21 with or from each data line 102 in response to the control of the controller 12 (control section 202). Note herein that the initialization voltage V21 is roughly the same as the threshold voltage of the drive transistor TTT of each pixel portion 101. Note also that the raster cycle period is divided into an initialization time period, the setting preparation time period and the current setting time period and that during the initialization time period, the controller 12 controls the connection switch section 22 to connect the voltage supply section 21 with the data lines 102, 102, . . . .

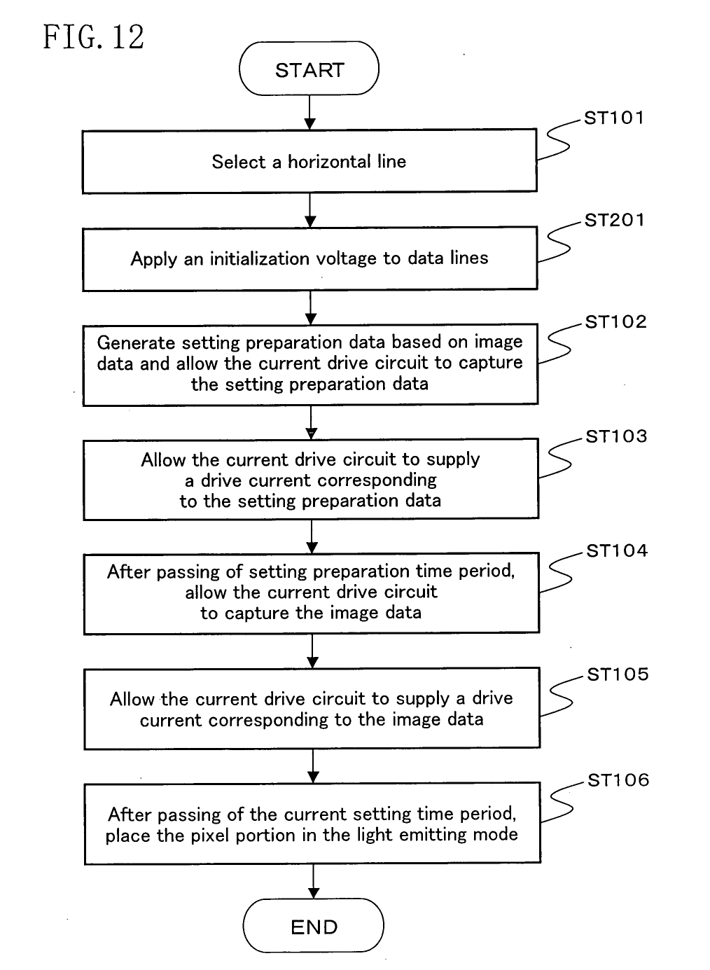

The operation of the display apparatus of FIG. 11 will be described with reference to FIG. 12. This display apparatus executes processing of step ST201 between the steps ST101 and ST102.

[Step ST201]

The controller 12 controls the connection switch section 22 to connect the voltage supply section 21 with the data lines 102, 102, . . . . With this connection, the initialization voltage V21 from the voltage supply section 21 is applied to the data lines 102, 102, . . . , making the voltages of the data lines 102, 102, . . . and the pixel portions 101, 101, . . . (pixel portions placed in the current copy mode) equal to the initialization voltage V21. After the passing of the initialization time period P0, the processing of the step ST102 is executed.

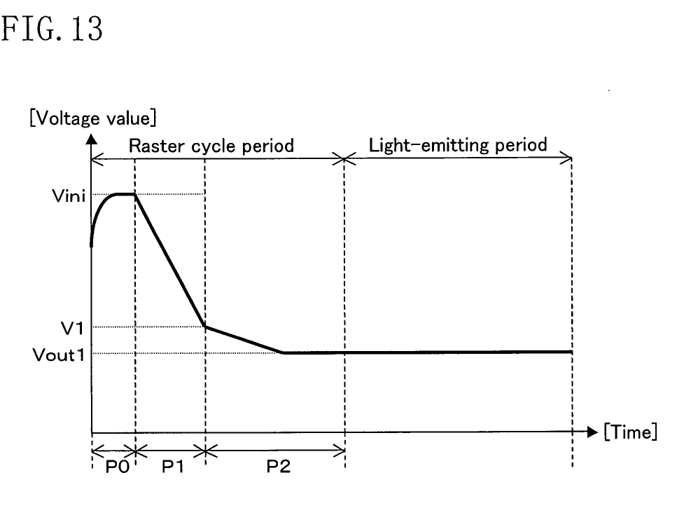

Hereinafter, the voltage change in one pixel portion 101 of the display panel 11 will be described with reference to FIG. 13.

When the horizontal lines of the display panel 11 are driven line by line sequentially, there is a high possibility that a data line 102 has a voltage value corresponding to the drive current supplied one line earlier (i.e., the target voltage value corresponding to one-line preceding image data). For this reason, if supply of the drive current is started without initializing the data line 102, the discharge amount of the data line 102 may possibly be excessive or short. In this embodiment, since the initialization voltage V21 is applied to the data line 102 during the initialization time period P0, the voltage value of the data line 102 and the pixel portion 101 is set at a voltage value Vini of the initialization voltage as shown in FIG. 13. In this way, by setting the voltage value of the data line 102 and the pixel portion 101 at a predetermined initialization value, the data line 102 and the pixel portion 101 can be discharged during the setting preparation time period P1 with no excess or shortage.

As described above, by initializing the voltage of each data line 102, the residual voltage in the load capacitance of the current drive circuit 13 can be removed. This permits appropriate discharging of the load capacitance of the current circuit 13 during the setting preparation time period P1, and thus correct write of the drive current Iout1 corresponding to the image data DD1 into a pixel portion 101 during the current setting time period P2.

### Alteration to Embodiment 2

The configuration may be made so that the length of the setting preparation time period P1 and the voltage value Vini of the initialization voltage can be set arbitrarily with external control and the like. Also, in the processing of conversion from the image data DD1 to the setting preparation data DD2 (processing of the step ST102 shown in FIG. 12), the digital value of the setting preparation data DD2 may be determined based on the digital value of the image data DD1, the capacitance value C of the load capacitance of the current drive circuit 13, the length T1 of the setting preparation time period and the voltage value of the initialization voltage V21.

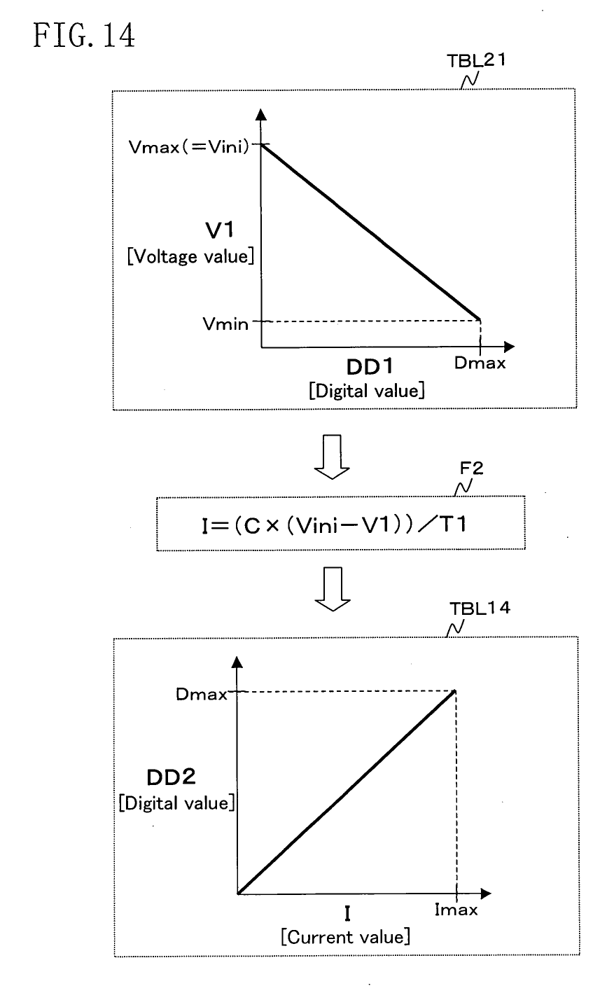

Referring to FIG. 14, an alteration to the processing of the step ST102 shown in FIG. 12 will be described. Assume that the conversion section 203 has conversion tables TBL21 and TBL14 and a conversion equation F2. The conversion table TBL21 indicates the correspondence between the image data DD1 and a target voltage value V1 during the setting preparation time period P1 (desired voltage value of the pixel portion 101 at the end of the setting preparation time period P1), in which the smaller the digital value of the image data DD1 is, the greater the target voltage value V1 is. The minimum value Vmin of the target voltage value V1 may be “0 V”.

First, the capacitance value C of the load capacitance of the current drive circuit 13, the length T1 of the setting preparation time period and the voltage value Vini of the initialization voltage are set with external control. Thereafter, the conversion section 203 acquires the target voltage value V1 corresponding to the digital value of the image data DD1 using the conversion table TBL21, and then substitutes the acquired target voltage value V1, the capacitance value C and the length T1 of the current setting time period into the conversion equation F2, to calculate the desired value I of the drive current Iout2. The conversion 203 then determines the digital value of the setting preparation data DD2 corresponding to the calculated desired value I of the drive current Iout2 using the conversion table TBL14.

As described above, the digital value of the setting preparation data DD2 is determined based on various parameters related to the current drive circuit 13 and the display panel 11. This permits appropriate setting of the discharge amount during the setting preparation time period P1, and thus correct write of the drive current Iout1 corresponding to the image data DD1 into the pixel portion 101.

### Embodiment 3

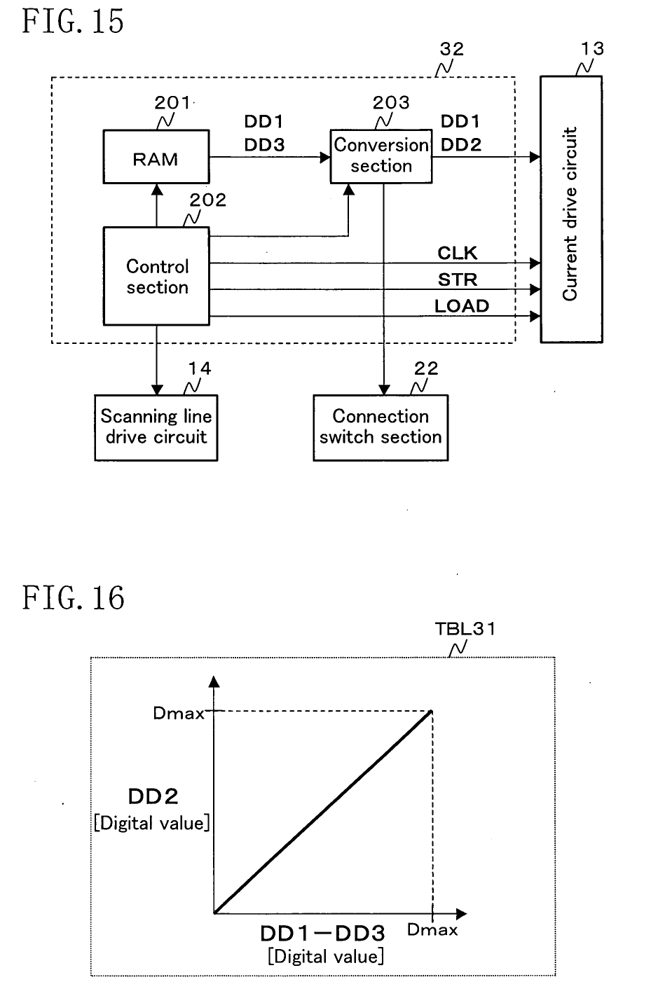

A display apparatus of Embodiment 3 of the present invention has the same configuration as that of FIG. 11, except that a controller 32 shown in FIG. 15 is provided in place of the controller 12 shown in FIG. 11. In the controller 32, the control section 202 transfers the image data DD1 and one-line preceding image data DD3 corresponding to the image data DD1 from the RAM 201 to the conversion section 203. The one-line preceding image data DD3 is a unit of image data corresponding to the same data line 102 as the current image data DD1, among image data corresponding to the immediately preceding horizontal line. In the conversion mode, the conversion section 203 compares sizes between the image data DD1 and the image data DD3, and executes generation of the setting preparation data DD2 and control of the connection switch section 22 according to the comparison result. Also, the conversion section 203 generates the setting preparation data DD2 based on the difference value between the image data DD1 and the image data DD3, in addition to generating the setting preparation data DD2 based on the image data DD1. For example, the conversion section 203 determines the digital value of the setting preparation data DD2 using a conversion table TBL31 shown in FIG. 16. In the conversion table TBL31, the greater the difference value between the image data DD1 and the image data DD3 (DD1-DD3) is, the greater the digital value of the setting preparation data DD2 is.

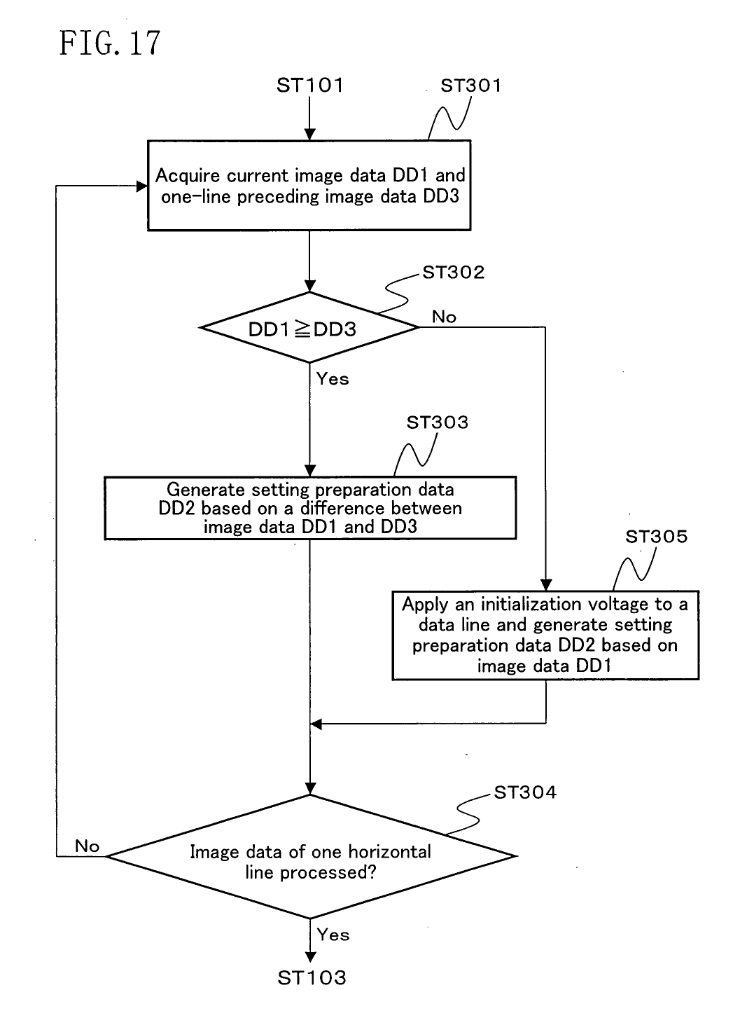

The operation of the display apparatus of Embodiment 3 will be described with reference to FIG. 17. This display apparatus executes the following processing in place of the step ST102 shown in FIG. 5. The other processing is substantially the same as that in FIG. 5.

[Step ST301]

In the controller 32, the control section 202 sets the operation mode of the conversion section 203 at the conversion mode. Also, the control section 202 transfers the image data DD1 and the one-line preceding image data DD3 corresponding to the image data DD1 from the RAM 201 to the conversion section 203.

[Step ST302]

The conversion section 203 judges whether the image data DD1 is smaller or greater than the image data DD3. If the digital value of the image data DD1 is equal to or greater than the digital value of the image data DD3, the process proceeds to step ST303. Otherwise, the process proceeds to step ST305.

[Step ST303]

The conversion section 203 generates the setting preparation data DD2 based on the difference value between the image data DD1 and DD3 and supplies the generated setting preparation data DD2 to the current drive circuit 13. In the current drive circuit 13, the setting preparation data DD2 is captured by the data line drive section 103 corresponding to the setting preparation data DD2 in question.

[Step ST304]

Once the image data DD1 of one horizontal line has been processed, the process proceeds to the step ST103. Otherwise, the process returns to the step ST301.

[Step ST305]

If judging that the image data DD1 is smaller than the image data DD3 in the step ST302, the conversion section 203 instructs the connection switch section 22 to connect the data line 102 corresponding to the current image data DD1 with the voltage supply section 21. This permits the initialization voltage V21 from the voltage supply section 21 to be transmitted to the data line 102 in question and then to the pixel portion 101 corresponding to the data line 102 (pixel portion placed in the current copy mode). Also, the conversion section 203 generates the setting preparation data DD2 based on the image data DD1 and supplies the generated setting preparation data DD2 to the current drive circuit 13. The process then proceeds to the step ST304.

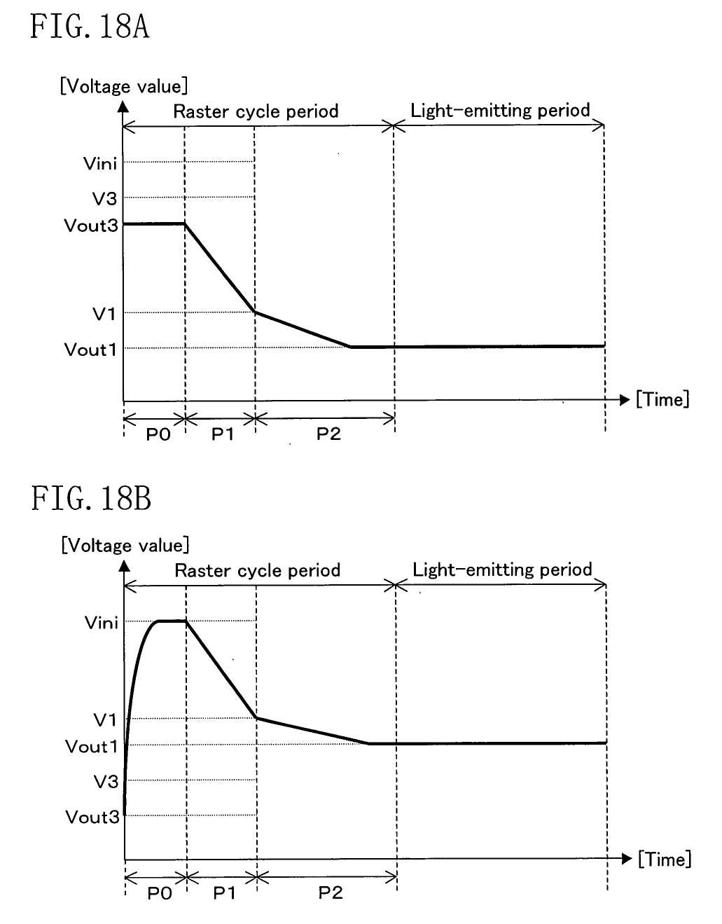

Hereinafter, the voltage change in one data line 102 of the display panel 11 will be described with reference to FIGS. 18A and 18B.

When the image data DD1 is greater than the image data DD3, the target voltage value Vout1 corresponding to the image data DD1 is lower than a target voltage value Vout3 corresponding to the one-line preceding image data DD3 (i.e., the voltage value of the data line 102 at the time before start of the processing) as shown in FIG. 18A. In this case, since the initialization voltage V21 is not applied to the data line 102 during the initialization time period P0, the voltage of the data line 102 and the pixel portion 101 remains at the target voltage value Vout3. With start of the next setting preparation time period P1, the drive current Iout2 corresponding to the difference value between the image data DD1 and the image data DD3 is supplied, allowing discharge of the data line 102 and the pixel portion 101. The discharge amount during the setting preparation time period P1 is smaller as the difference value between the image data DD1 and the image data DD3 is smaller.

When the image data DD1 is smaller than the image data DD3, the target voltage value Vout1 is higher than the voltage value of the data line 102 (target voltage value Vout3) as shown in FIG. 18B. In this case, the initialization voltage V21 is applied to the data line 102 during the initialization time period P0, raising the voltage of the data line 102 and the pixel portion 101 to the voltage value Vini of the initialization voltage. Thereafter, the drive current Iout2 is supplied, as in Embodiment 2, allowing discharge of the data line 102 and the pixel portion 101.

As described above, the voltage value for the drive current Iout2 is determined based on the difference value between the current image data DD1 and the one-line preceding image data DD3. With this, the discharge amount during the setting preparation time period P1 can be set appropriately. Also, since whether initialization is necessary or not is judged based on whether the current image data DD1 is greater or smaller than the one-line preceding image data DD3, unnecessary initialization of the voltage value of the load capacitance of the current drive circuit 13 can be prevented. This can reduce the power consumption of the current drive circuit 13.

### Alteration to Embodiment 3

In the processing of generating the setting preparation data DD2 based on the difference value between the image data DD1 and DD3 (processing of step ST303 shown in FIG. 17), the digital value of the setting preparation data DD2 may be determined based on the digital value of the image data DD1, the digital value of the image data DD3, the capacitance value C of the load capacitance of the current drive circuit 13 and the length T1 of the setting preparation time period.

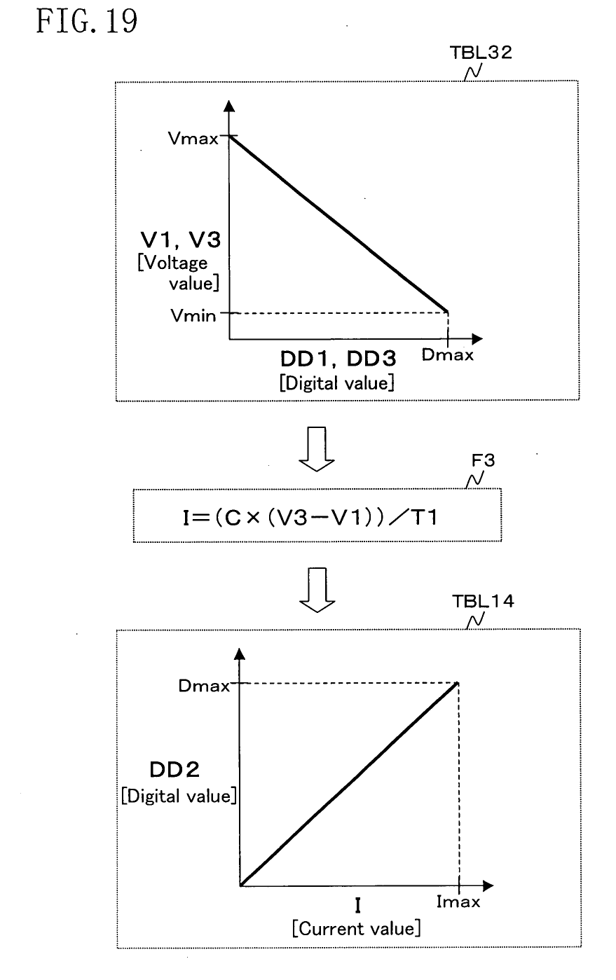

An alteration to the processing of the step ST303 shown in FIG. 17 will be described with reference to FIG. 19. Assume that the conversion section 203 has conversion tables TBL32 and TBL14 and a conversion equation F3. The conversion table TBL32 indicates the correspondence between the image data DD1 (DD3) and the target voltage value V1 (V3) during the setting preparation time period P1, in which the smaller the digital value of the image data DD1 (DD3) is, the greater the target voltage value V1 (V3) is.

First, the capacitance value C of the load capacitance of the current drive circuit 13 and the length T1 of the setting preparation time period P1 are set with external control. Thereafter, the conversion section 203 acquires the target voltage value V1 corresponding to the image data DD1 and the target voltage value V3 corresponding to the image data DD3 using the conversion table TBL32, and then substitutes the acquired target voltage values V1 and V3, the capacitance value C and the length T1 of the current setting time period into the conversion equation F3, to calculate the desired value I of the drive current Iout2. The conversion section 203 then determines the digital value of the setting preparation data DD2 corresponding to the calculated desired value I of the drive current Iout2 using the conversion table TBL14.

As described above, the digital value of the setting preparation data DD2 is determined based on various parameters related to the current drive circuit 13, the display panel 11 and the like. This permits appropriate setting of the discharge amount during the setting preparation time period P1, and thus correct write of the drive current Iout1 corresponding to the image data DD1 into the pixel portion 101.

### Other Embodiments

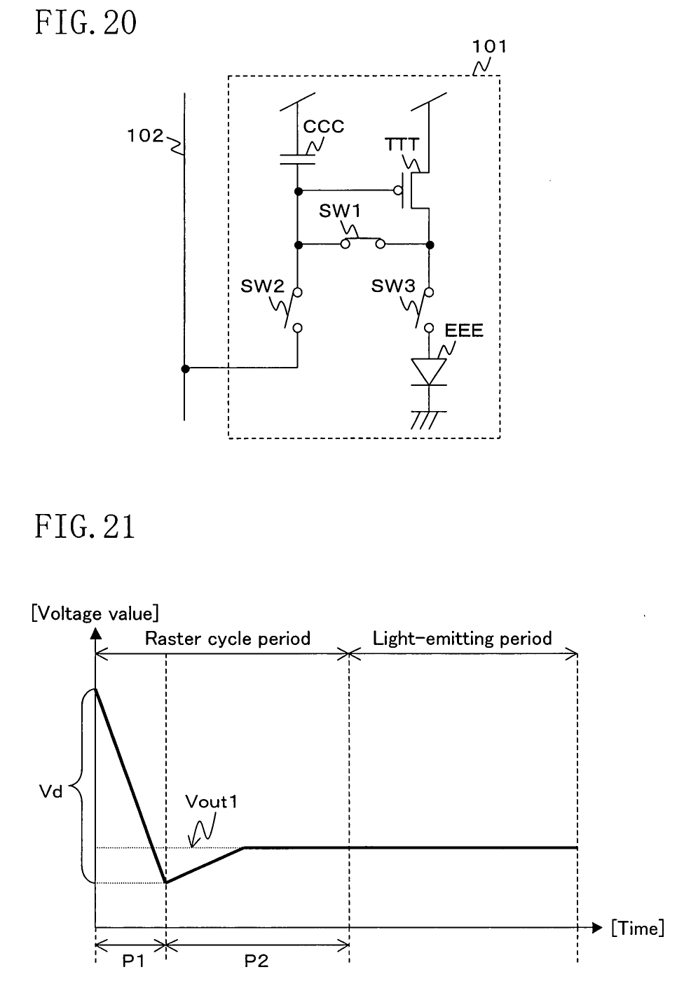

In the embodiments described above, there is a high possibility that a pixel portion 101 has a voltage value corresponding to the drive current supplied one frame earlier (i.e., the target voltage value corresponding to one-frame preceding image data). Therefore, the discharge amount of the pixel portion 101 may possibly become excessive or short. To overcome this problem, the controller 12 may instruct the scanning line drive circuit 14 to control each of the pixel portions 101, 101, . . . in the following manner before the drive current is supplied to each of the data lines 102, 102, . . . In this case, each of the pixel portions 101, 101, . . . has an initialization mode in addition to the current copy mode and the current drive mode. As shown in FIG. 20, when the pixel portion 101 is placed in the initialization mode, in which the switch SW1 is ON while the switches SW2 and SW3 are OFF, the gate and drain of the drive transistor TTT are connected with each other, causing the gate voltage of the drive transistor TTT to vary. As a result, the voltage of the capacitor CCC becomes equal to the threshold voltage of the drive transistor TTT. The scanning line drive circuit 14 places the pixel portions 101, 101, . . . of the display panel 11 in the initialization mode before start of the processing of the step ST102. After the passing of a predetermined time period (for example, the time period from the placement in the initialization mode until the gate voltage of the drive transistor TTT is stabilized), the scanning line drive circuit 14 places the pixel portions 101, 101, . . . in the current copy mode, to start the processing of the step ST102.

As described above, each of the pixel portions 101, 101, . . . is allowed to hold a threshold voltage specific to its drive transistor TTT in its capacitor CCC. Therefore, the voltage of each of the pixel portions 101, 101, . . . can be initialized appropriately according to the transistor characteristic of the drive transistor TTT. In other words, the residual voltage in each of the pixel portions 101, 101, . . . can be removed, permitting appropriate discharge of each of the pixel portions 101, 101, . . . For example, even if the transistor characteristics of the drive transistors TTT vary among the pixel portions 101, 101, . . . , it is unnecessary to initialize the pixel portions 101, 101, . . . individually. Moreover, each of the pixel portions 101, 101, . . . may be placed in the current copy mode before being placed in the initialization mode, and the initialization voltage V21 may be applied to the data lines 102, 102, . . . This will shorten the time required for the voltage of the capacitor CCC to be converged to the threshold voltage of the drive transistor TTT in each of the pixel portions 101, 101, . . .

In the embodiments described above, the voltage value of each pixel portion 101 is controlled to be close to the target voltage value Vout1 during the setting preparation time period. Alternatively, as shown in FIG. 21, control may be made so that the voltage value of each pixel portion 101 reaches the target voltage value Vout1 within the setting preparation time period P1. In this case, the charge amount during the current setting time period P2 may be calculated based on the current value of the drive current Iout1 and the length of the current setting time period P2, to determine the discharge amount Vd based on the calculated charge amount and then determine the digital value of the setting preparation data DD2.

The correspondence in the conversion tables TBL11, TBL12, TBL13, TBL21, TBL31 and TBL32 may be linear or nonlinear. Otherwise, each conversion table may be expressed by a function, and the conversion section 203 may execute computation using the function, to thereby acquire the setting preparation data DD2. For example, the conversion table TBL14 in FIG. 10 can be expressed by

Digital value of setting preparation data DD2=(Imax/1)×Dmax

where “I” denotes a desired value of the drive current Iout2, “Imax” denotes the maximum value of the drive current Iout2, and “Dmax” denotes the maximum value of the setting preparation data DD2. Each parameter may be set based on the size of the display panel 11, the fabrication process of the display panel 11 and the like. The parameters for determining the setting preparation data DD2 are not limited to those shown in the conversion tables and the like described above, but the output performance of the current drive circuit 13 (maximum value of the drive current), the wiring delay between the controller 12 and the current driving circuit 13 and the like may be used instead.

The controller 12 and the current drive circuit 13 may be formed on the same integrated circuit. More specifically, the controller 12 and the current drive circuit 13 may be integrated as a display panel drive device. Otherwise, the controller 12 and the current drive circuit 13 may be embedded in a frame portion (periphery of the display screen) of the display panel 11. In other words, the controller 12, the current drive circuit 13 and the display panel 11 may be integrated to configure a display apparatus. With such a configuration, no connection pad will be necessary for connection among the circuits, and thus the mount area can be reduced. Also, the inter-circuit wiring length can be shortened.

In the embodiments described above, each of the function blocks in the controller 12, 32 can generally be implemented by MPU, memory and the like. The processing performed by each of the function blocks can be normally implemented by software (program), and the software is recorded on a recording medium such as a ROM. Such software may be distributed by downloading and the like, or via a recording medium such as a CD-ROM. Naturally, each function block can also be implemented by hardware (exclusive circuit).

Note that although the current drive circuits of a current ejection type were exemplified in the description described above, a current drive circuit of a current pull-in type can also be controlled.

As described above, according to the present invention, write of a drive current can be completed within a predetermined time period without increasing the circuit scale of the current drive circuit. The present invention is therefore applicable to a current-driven display apparatus, a printer driver and the like.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A drive control method for controlling a current drive circuit, the current drive circuit supplying a drive current having a current value corresponding to a digital value of digital data to a current-driven circuit to be driven, the method comprising the steps of:
(a) supplying second digital data, in place of first digital data that should originally be supplied, to the current drive circuit to allow the current drive circuit to supply a drive current corresponding to the second digital data during a first time period; and
(b) supplying the first digital data to the current drive circuit after the step (a) to allow the current drive circuit to supply a drive current corresponding to the first digital data during a second time period,
wherein in the step (a), the digital value of the second digital data is determined based on the digital value of the first digital data so that write of a drive current corresponding to the first digital data into the circuit to be driven is completed with the supply of the drive currents during the first and second time periods.

2. The drive control method of claim 1, wherein in the step (a), the digital value of the second digital data is determined so as to be greater as the digital value of the first digital data is smaller.

3. The drive control method of claim 1, wherein in the step (a), the digital value of the second digital data is determined so as to be greater than the digital value of the first digital data if the digital value of the first digital data is smaller than a predetermined value, or the digital value of the first digital data is supplied as the second digital data if the digital value of the first digital data is equal to or greater than the predetermined value.

4. The drive control method of claim 1, further comprising the step of (c) initializing the voltage value of the circuit to be driven before allowing the current drive circuit to supply the drive current in the step (a).

5. The drive control method of claim 1, where the step (a) comprises the steps of:
(a1) judging which is greater, the first digital data or third digital data that is digital data previously supplied to the current drive circuit;
(a2) determining the digital value of the second digital data so as to be greater as a difference value between the first digital data and the third digital data is greater if it is judged that the first digital data is equal to or greater than the third digital data in the step (a1); and
(a3) initializing the voltage value of the circuit to be driven and determining the digital value of the second digital data so as to be greater as the digital value of the first digital data is smaller if it is judged that the first digital data is smaller than the third digital data in the step (a1).

6. The drive control method of claim 1, wherein the circuit to be driven includes a current-driven drive element, a drive transistor for supplying a current to the drive element, and a voltage hold element connected to a gate of the drive transistor for holding a gate voltage of the drive transistor, and
the method comprises the steps of:
(d) connecting the gate and drain of the drive transistor with each other before allowing the current drive circuit to supply the drive current in the step (a), to permit the voltage hold element to hold a gate voltage of the drive transistor obtained when no current is flowing through the drive transistor;
(e) connecting the drive transistor with the current drive circuit during the first and second time periods to allow the drive transistor to receive the drive current supplied from the current drive circuit and then the voltage hold element to hold a gate voltage corresponding to a current value at the drive transistor; and
(f) connecting the drive transistor with the drive element after passing of the second time period to allow the drive element to receive a current corresponding to the gate voltage held in the voltage hold element.

7. A drive control device for controlling a current drive circuit, the current drive circuit supplying a drive current having a current value corresponding to a digital value of digital data to a current-driven circuit to be driven, the device comprising:
a conversion section for supplying second digital data, in place of first digital data that should originally be supplied, to the current drive circuit during a first time period and supplying the first digital data to the current drive circuit during a second time period that comes after the first time period; and
a control section for controlling the current drive circuit to receive the second digital data from the conversion section and supply a drive current corresponding to the second digital data during the first time period, and controlling the current drive circuit to receive the first digital data from the conversion section and supply a drive current corresponding to the first digital data during the second time period,
wherein the conversion section determines the digital value of the second digital data based on the digital value of the first digital data so that write of a drive current corresponding to the first digital data into the circuit to be driven is completed with the supply of the drive currents during the first and second time periods.

8. The drive control device of claim 7, wherein the conversion section determines the digital value of the second digital data so as to be greater as the digital value of the first digital data is smaller.

9. The drive control device of claim 7, wherein the conversion section determines the digital value of the second digital data so as to be greater than the digital value of the first digital data if the digital value of the first digital data is smaller than a predetermined value, or supplies the digital value of the first digital data as the second digital data if the digital value of the first digital data is equal to or greater than the predetermined value.

10. The drive control device of claim 7, further comprising a voltage initialization section for initializing the voltage value of the circuit to be driven,
wherein the control section controls the voltage initialization section to initialize the voltage value of the circuit to be driven before allowing the current drive circuit to supply the drive current.

11. The drive control device of claim 7, further comprising a voltage initialization section for initializing the voltage value of the circuit to be driven,
wherein if the first digital data is equal to or greater than third digital data that is digital data previously supplied to the current drive circuit, the conversion section determines the digital value of the second digital data so as to be greater as a difference value between the first digital data and the third digital data is greater, and
if the first digital data is smaller than the third digital data, the conversion section instructs the voltage initialization section to initialize the voltage value of the circuit to be driven and determines the digital value of the second digital data so as to be greater as the digital value of the first digital data is smaller.

12. The drive control device of claim 7, wherein the circuit to be driven includes a current-driven drive element, a drive transistor for supplying a current to the drive element, a voltage hold element connected to a gate of the drive transistor for holding a gate voltage of the drive transistor, and a connection state switch element for switching the connection state of the drive transistor, and
the control section controls:
the connection state switch element to connect the gate and drain of the drive transistor with each other before allowing the current drive circuit to supply the drive current, to permit the voltage hold element to hold a gate voltage of the drive transistor obtained when no current is flowing through the drive transistor;
the connection state switch element to connect the drive transistor with the current drive circuit during the first and second time periods to allow the drive transistor to receive the drive current supplied from the current drive circuit and then the voltage hold element to hold a gate voltage corresponding a current value at the drive transistor; and
the connection state switch element to connect the drive transistor with the drive element after passing of the second time period to allow the drive element to receive a current corresponding to the voltage held in the voltage hold element.

13. A display panel drive device comprising:
a current drive circuit for supplying a drive current having a current value corresponding to a digital value of image data to a pixel portion of a current-driven display panel; and
a drive control circuit for supplying setting preparation data, in place of image data that should originally be supplied, to the current drive circuit to allow the current drive circuit to supply a drive current corresponding to the setting preparation data during a setting preparation time period, and supplying the image data to the current drive circuit to allow the current drive circuit to supply a drive current corresponding to the image data during a current setting time period that comes after the setting preparation time period, the drive control circuit determining the digital value of the setting preparation data based on the digital value of the image data so that write of a drive current corresponding to the image data into the pixel portion with the supply of the drive currents during the setting preparation time period and the current setting time period.

14. A display apparatus comprising:
the display panel drive device of claim 13; and
a display panel having the display panel drive device embedded therein.

15. A recording medium for storing a drive control program for permitting a computer to execute control over a current drive circuit for supplying a drive current having a current value corresponding to a digital value of digital data to a current-driven circuit to be driven, the program comprising the steps of:
(a) supplying second digital data, in place of first digital data that should originally be supplied, to the current drive circuit to allow the current drive circuit to supply a drive current corresponding to the second digital data during a first time period; and
(b) supplying the first digital data to the current drive circuit after the step (a) to allow the current drive circuit to supply a drive current corresponding to the first digital data during a second time period,
wherein in the step (a), the digital value of the second digital data is determined based on the digital value of the first digital data so that write of a drive current corresponding to the first digital data into the circuit to be driven is completed with the supply of the drive currents during the first and second time periods.
